(19) United States
(12) Patent Application Publication
(10) Pub. No.: US 2024/0181988 A1
(43) Pub. Date: Jun. 6, 2024

(54) Vehicle, Computer Program, Method and Transceiver Circuit for a Vehicle

(71) Applicant: Bayerische Motoren Werke Aktiengesellschaft, Muenchen (DE)

(72) Inventors: Marjan Buzanin, Muenchen (DE); Marc Landschulze, Schwarzach (DE)

(21) Appl. No.: 18/550,060

(22) PCT Filed: Feb. 1, 2022
(86) PCT No.: PCT/EP2022/052268

§ 371 Date: Sep. 11, 2023

(30) Foreign Application Priority Data
Apr. 21, 2021 (DE) 10 2021 110 138.7

(51) Int. Cl. B60R 25/31

(52) U.S. Cl. CPC B60R 25/31

(57) ABSTRACT

A transceiver circuit for a vehicle includes at least one transceiver and a control module for the transceiver. The control module is configured to communicate information relating to a locking/unlocking of the vehicle with a communication device of the user using the transceiver. The control module is further configured to gather information relating to a passenger compartment of the vehicle using the transceiver.

The present application is the U.S. national phase of PCT Application PCT/EP2022/052268 filed on Feb. 1, 2022, which claims priority of German patent application No. 102021110138.7 filed on Apr. 21, 2021, which is incorporated herein by reference in its entirety.

### TECHNICAL FIELD

The disclosure relates generally to monitoring a passenger compartment of a vehicle and to controlling access to the vehicle.

### BACKGROUND

Vehicles are increasingly being equipped with sensor systems for occupant detection. Sensor systems of this type provide, for example, 24 GHz or 60 GHz radar sensors or pressure-based presence sensors. The implementation of sensor systems of this type therefore requires an implementation of corresponding radar sensors and/or pressure sensors. In particular, coverage of the passenger compartment of the vehicle that is as complete as possible can be desired, and it is therefore often provided to arrange a plurality of radar sensors and/or pressure sensors of this type in a distributed manner in the passenger compartment of the vehicle. The implementation of sensor systems for occupant detection therefore requires high integration outlay.

A need therefore exists for an improved concept for monitoring the passenger compartment of a vehicle.

### SUMMARY

According to a basic concept of the present disclosure, components which are provided for locking and/or unlocking and for communication with the communication device of a user are additionally used for occupant detection in the interests of reduced integration outlay. Vehicles are equipped, for example, with ultra-wideband (UWB) technology, for example a UWB receiver and/or UWB transmitter for (encrypted) communication with the communication device, thus enabling the vehicles to be unlocked and/or locked using the communication device. According to some embodiments, it is proposed, in the interests of low integration outlay, to use transceivers and/or transmitters provided for communication with the communication device additionally for occupant detection.

Exemplary embodiments provide a transceiver circuit for a vehicle. The transceiver circuit comprises at least one transceiver and a control module for the transceiver. The control module is designed to communicate information relating to a locking/unlocking of the vehicle with a communication device of the user using the transceiver and to gather information relating to a passenger compartment of the vehicle using the transceiver. In other words, the same transceiver is used to gather the information relating to the passenger compartment of the vehicle and also to communicate the information relating to the locking/unlocking of the vehicle. The same circuit, for example, for the signal generation of the transceiver, the same antenna arrangement of the transceiver and/or the same interface of the transceiver to the control module are used here. In the interests of lower integration outlay, this eliminates the need for separate components for acquiring and communicating the aforementioned information.

The transceiver can be designed, in particular, as an ultra-wideband transceiver. In the context of the present disclosure, ultra-wideband technology is to be understood to mean, in particular, an approach to localization and short-range radio communication using (wirelessly electromagnetic signals having a bandwidth transmitted) of at least 500 MHz or of at least 20% of the arithmetic mean value of the lower and upper limit frequencies of the signals. An ultra-wideband transceiver can be understood accordingly to mean a transceiver for transmitting and receiving signals of this type. Compared with “narrower-band” approaches, which provide a smaller bandwidth, UWB allows, on one hand, a higher data rate for communication with the communication device and, on the other hand (according to the constant time-bandwidth product principle), in the interests of I precise localization, a smaller temporal pulse width. The information relating to the passenger compartment gathered with the ultra-wideband transceiver can accordingly be more precise and trustworthy than with the use of a smaller bandwidth. The larger bandwidth further allows a lower power density, offering the benefit of less interference with other signals. UWB further allows the detection and resolution of multipath reception or multipath propagation and therefore the avoidance of resulting errors, e.g. in the information relating to the passenger compartment.

Alternatively, the transceiver can be adapted to use other technologies for gathering the information relating to the passenger compartment and/or for communicating the information relating to the locking/unlocking. The transceiver is alternatively designed, for example, as a

Bluetooth transceiver, Bluetooth low-energy transceiver, or is adapted for the use of signals in the 24 GHz or 60 GHz frequency band.

The transceiver can be arranged in the passenger compartment of the vehicle for protection against the effects of the weather and manipulation and in the interests of better, in particular more precise, information relating to the passenger compartment.

According to some exemplary embodiments, the transceiver is designed to transmit a communication signal between the communication device and the transceiver in order to communicate the relating information to the locking/unlocking of the vehicle, and to transmit a measurement signal into the passenger compartment in order to gather the information relating to the passenger compartment using the measurement signal or a reflection of the measurement signal.

The communication device can be located at least temporarily outside the vehicle, for example if the user of the communication device and of the vehicle is carrying it with him outside the vehicle. the transceiver is arranged in the passenger compartment of the vehicle, the communication signal can be transmitted accordingly between the passenger compartment and the environment of the vehicle for the communication between the transceiver and the communication device. The communication signal can furthermore also be emitted into the passenger compartment in order to allow communication between the transceiver and the communication device if the communication device is located in the passenger compartment of the vehicle.

The communication signal can be a signal which is received from the communication device or is transmitted to the communication device using the transceiver.

The communication signal and the measurement signal can, in particular, be separately transmitted signals. The communication signal and the measurement signal comprise, for example, one or more pulses, wherein the pulses of the communication signal are temporally separated from the pulses of the measurement signal during the transmission of the communication signal and the measurement signal. Optionally, the communication signal is modulated onto the measurement signal or the measurement signal is modulated onto the modulation signal. The communication signal can be modulated onto the measurement signal by means of a modulation method for this purpose. Examples of modulation methods are pulse-position modulation (PPM), pulse-amplitude modulation (PAM) (binary) phase shift keying ((B) PSK) and on-off keying (OOK).

According to some exemplary embodiments, the transceiver circuit comprises at least one further transceiver which is designed to receive the measurement signal or the reflection of the measurement signal, and wherein the control module is designed to gather the information relating to the passenger compartment of the vehicle using the received measurement signal or the reflection of the measurement signal. This allows the measurement signal or the reflection of the measurement signal to be received by the transceiver and the further transceiver in the interests of greater accuracy and/or the information relating to trustworthiness of the passenger compartment.

The communication signal is a first ultra-wideband signal and the measurement signal is a second ultra-wideband signal. In other words, both the communication signal and the measurement signal can be an ultra-wideband signal (UWB signal). As already explained, the measurement signal and the communication signal can be modulated onto one another. The first and the second UWB signal can accordingly be a UWB signal in which the communication signal and the measurement signal are modulated onto one another. UWB signals allow a higher transmission rate compared with narrower-band approaches. The transmission rate for communicating the information relating to the locking/unlocking of the vehicle can accordingly be higher. UWB signals further have a better material penetration compared with narrower-band signals. As a UWB signal, the measurement signal can accordingly offer more complete coverage of the passenger compartment. As a result, compared with technologies which use narrower-band signals, a smaller number of transceivers can be required for the sensor-based monitoring of the passenger compartment or for gathering the information relating to the passenger compartment.

The communication signal and the measurement signal can have a frequency between 1 GHz and 20 GHZ in the interests of a better material penetration than signals having other frequencies. The measurement signal and/or the communication signal can optionally also have higher or lower frequencies.

The information relating to the passenger compartment can comprise, in particular, information relating to one or more objects or occupants in the passenger compartment.

The information relating to the passenger compartment comprises, for example, information relating to one or more occupants of the passenger compartment, in particular relating to a presence, a position, a sign of life, an emotional state, age and/or state of health of the occupants. This allows functions of the vehicle to be performed on the basis of this information, for example for the automatic adaptation of the passenger compartment or of the vehicle according to the occupants. Information relating to the passenger compartment can be used, for example, for the adaptive activation/deactivation of airbags. The information relating to the passenger compartment optionally comprises information relating to gestures of one or more occupants for gesture control.

The control module can further be designed to use the information relating to the locking/unlocking of the vehicle and the information relating to the passenger compartment of the vehicle, in particular, for protection against theft and/or for the protection of occupants. As a result, in particular, it is possible to establish a presence of persons after the locking of the vehicle and therefore determine whether persons or animals have been left behind at their risk in the passenger compartment, or whether activities relating to theft are taking place in the passenger compartment of the vehicle. If the information relating the to passenger compartment indicates, for example, a presence of persons in the passenger compartment after the locking/unlocking the vehicle, an attempted theft and/or the presence of persons or animals that have left behind in the passenger compartment can be inferred.

Further exemplary embodiments provide a vehicle comprising a transceiver circuit proposed herein.

Further exemplary embodiments provide a method for a vehicle (producing the same effect as the transceiver circuit). The method comprises communicating information relating to a locking/unlocking of the vehicle with a communication device of a user using a transceiver. The method further comprises gathering information relating to the passenger compartment of the vehicle using the transceiver.

Further exemplary embodiments provide a computer program having a program code which causes the proposed method to be carried out when the program code is executed on a programmable hardware component.

Exemplary embodiments are explained in detail below with reference to the attached figures.

### BRIEF DESCRIPTION OF THE DRAWINGS

FIG. 1 shows a block diagram for the schematic representation of an exemplary embodiment of a transceiver circuit for a vehicle;

FIG. 2a shows a schematic representation of a side view of a vehicle comprising an exemplary embodiment of the transceiver circuit;

FIG. 2b shows a schematic representation of a top view of the vehicle of FIG. 2a;

FIG. 2c shows a schematic representation of a front view of the vehicle of FIG. 2a; and

FIG. 3 shows a flow diagram for the schematic representation of an exemplary embodiment of a method for a vehicle.

### DETAILED DESCRIPTION

Different exemplary embodiments will now be described in more detail with reference to the attached drawings in which some exemplary embodiments are shown. In the figures, the thickness dimensions of lines, layers and/or regions can be represented in an exaggerated manner for the sake of clarity. Optional features can be indicated by broken or dashed lines.

Although exemplary embodiments can be modified and changed in different ways, exemplary embodiments are shown in the figures as examples and are described in detail herein. However, it should be made clear that it is not intended to limit exemplary embodiments to the respectively disclosed forms, but rather that exemplary embodiments are intended to cover all functional and/or structural modifications, equivalents and alternatives that fall within the scope of the invention.

It should be noted that an element which is described as “connected” or “coupled” to another element can be connected or coupled directly to the other element or that intermediate elements can be present. Conversely, if an element is referred to as “directly connected” or “directly coupled” to another element, no intermediate elements are present. Other terms that are used to describe the relationship between elements should be interpreted in a similar manner (e. g. “between” as opposed to “directly between”, “adjacent” as opposed to “directly adjacent”, etc.).

The terminology used herein serves only to describe specific exemplary embodiments and is not intended to limit the exemplary embodiments. As used herein, the singular forms “a”, “an”, and “the” are intended to include the plural forms also, unless the context unequivocally indicates otherwise. It should further be made clear that expressions such as “contains”, “containing”, “has”, “comprises”, “comprising” and/or “having”, as used herein, indicate the presence of specified features, whole numbers, steps, work processes, elements, components and/or groups thereof, but do not exclude the presence or the addition of one or of one or more features, whole numbers, steps, work processes, elements, components and/or groups thereof.

Known concepts for occupant detection and control of vehicle access (locking/unlocking of the vehicle) using communication devices require the installation of separate systems, with resulting high integration outlay. A further disadvantage is that a large number of sensors are required in order to cover the entire passenger compartment. For passenger detection, known concepts provide passenger compartment radar systems using signals in the 60 GHz band. This frequency band is not regulated, so that future applications in the 60 GHz band can impair the functional performance of the passenger detection. Such signals further have only a small penetration of materials, resulting in incomplete coverage in the occupant detection, for example if the signals are prevented from detecting an object by vehicle backrests, child seats or other obstacles. At least some of the embodiments described herein reduce or eliminate the aforementioned disadvantages.

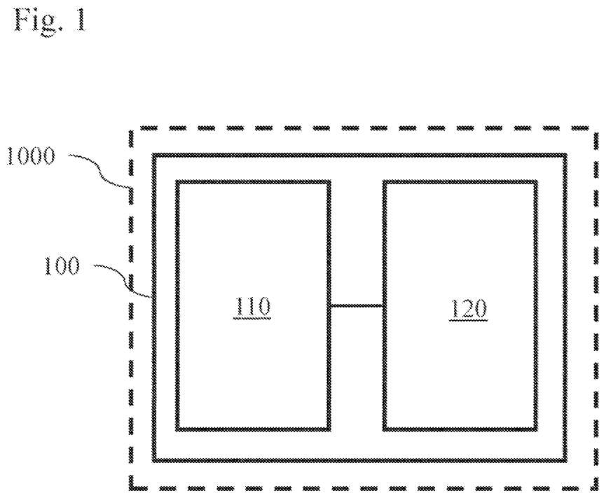

FIG. 1 shows a block diagram for the schematic representation of an exemplary the embodiment of transceiver circuit 100. As indicated by dashed lines, the transceiver circuit 100 is installed in exemplary embodiments in a vehicle 1000. The transceiver 110 is arranged, for example, in the passenger compartment of the vehicle.

The transceiver circuit 100 comprises at least one transceiver 110 and a control module 120 for the transceiver 110 which is designed not only to communicate information relating to a locking/unlocking of the vehicle 1000 with a communication device (not shown) of a user, but also to gather information relating to a passenger compartment of the vehicle 1000.

The control module 120 comprises, for example, an interface to the transceiver 110 and means for processing information. In exemplary embodiments, the control module 120 comprises, for example, a data processing circuit (e.g. a processor) and/or one or more components for digital and/or analog signal processing (e.g. amplifier (circuits), analog-to-digital converters (ADCs), digital-to-analog converters (DACs), digital signal processors (DSPs), integrated circuits (ICs), field programmable gate arrays (FPGAs), microcontrollers. The control module 120 is further configured, for example, to execute one or more computer programs for signal processing and/or information processing for communicating and gathering the information.

The transceiver 110 comprises, for example, an interface for communicating with the control module 120, means for signal processing, means for signal generation, an antenna, an antenna array comprising a plurality of antennas and/or other technical means or arrangements (e.g. sensors) for the (wireless) reception and/or transmission of electromagnetic signals. In some examples, the transceiver 110 comprises separate means for transmission and reception, e.g. in each case at least one separate antenna for reception and one separate antenna for transmission. The same means, e.g. the same antenna or the same antennas, are optionally used for transmission and reception.

In the interests of lower integration outlay, it is proposed to use the transceiver 110 at least partially (at least some of the components of the transceiver 110) not only for communication, for example transmission and information reception, of the relating to the locking/unlocking of the vehicle, but also for gathering the information relating to the passenger compartment. In exemplary embodiments, the same interface to the control module 120, for example, the same means of the transceiver for generating and/or processing signals and/or the same antenna of the transceiver 120 are used not only for the exchange with the communication device but also for monitoring the passenger compartment. As a result, for example, in the interests of lower technical outlay and lower costs of additional components, for example separate interfaces, transmitters, receivers and/or transceivers for the separate integration of occupant detection and communication with the communication device relating to vehicle access and/or the locking/unlocking of the vehicle can be dispensed with.

The transceiver circuit 100 can be used, in particular, in applications for locking and/or unlocking the vehicle using a communication device (external to the vehicle), such as, for example, a cell phone of the user. In such applications, it can be provided that the vehicle can be locked and/or unlocked for accessing the vehicle with the communication device, particularly if the user with the communication device is located outside the vehicle. The transceiver 110 according is designed to exemplary embodiments to communicate with the communication device, in particular, even if said communication device is located outside the vehicle. For this purpose, one or more antennas of the transceiver 110 can be designed, in particular, to transmit signals from the vehicle and/or to receive signals from the environment of the vehicle. In order to offer communication to the communication device all around the vehicle, the transceiver 110 can be designed, in particular, for omnidirectional reception and transmission of signals. The transceiver 110 can essentially also be adapted to communicate with the communication device when the communication device is located in the passenger compartment of the vehicle. In some exemplary embodiments, the transceiver 110 can also be designed for directional transmission and/or directional reception of signals.

The information relating to the locking/unlocking of the vehicle comprises, for example, information relating to a position and/or distance of the communication device relative to the vehicle for position-controlled and/or distance-controlled locking/unlocking of the vehicle. The information relating to the position and/or distance of the communication device is gathered, for example, by means of a delay-measuring or path-measuring method (e.g. by means of a unilateral or multilateral (delay-based) distance-measuring method) using the transceiver circuit 100. The information optionally comprises position data (e.g. geographical data) of the communication device which have been determined by a separate location system, for example by means of a satellite-based location system. The information relating to the locking/unlocking optionally further comprises information relating to an identifier of the communication device, a request and/or an authorization of the communication device or of the user to lock/unlock the vehicle.

The transceiver circuit 100 can further be used for the sensor-based detection, monitoring and/or characterization of the passenger compartment of the vehicle. Path-based and/or delay-based measuring methods, in particular, can be used for the sensor-based detection, monitoring and/or characterization. For this purpose, the transceiver 110 can be designed, in particular, to transmit signals into the passenger compartment and/or to receive signals from the passenger compartment. The control module 120 is designed accordingly, for example, to determine information relating to the position, size and/or distance of objects and/or the position, size, distance, age, state of health or emotional state of the occupants of the passenger compartment on the basis of a delay or path of the signals. A Doppler shift of the signals can optionally also be considered in order to detect and characterize, for example, information relating to movements or gestures of the occupants of the passenger compartment . Information relating to the position, size, distance, age, state of health, signs of life, gestures or emotional state of the occupants allows, for example, a characterization and/or classification of the occupants according to one of the information elements. The information further allows the vehicle (e.g. the arrangement of seats, screens or activation/deactivation of airbags) to be configured adaptively based on the information and/or, for example, if a critical state of health is present in the case of one or more occupants, to automatically make an emergency call. Information relating to the occupants, for example their age and/or their state of health, can be communicated automatically when the emergency call is made.

In exemplary embodiments, the transceiver 110 can be implemented as an ultra-wideband transceiver. The transceiver 110 accordingly has, for example, one or more means configured for the reception, processing and/or transmission of UWB signals, for example one or more antennas suitable for the use of UWB and/or processors for signal generation and/or signal processing.

As already mentioned, UWB signals have a wider frequency band than narrowband signals, such for example, signals in the 24 GHz or 60 GHz band. On one hand, the wider frequency band offers a higher transmission rate for communicating the information relating to the locking/unlocking of the vehicle and, on the other hand, it offers various advantages for gathering the information relating to the passenger compartment.

According to the constant time-bandwidth product principle, the wider frequency band allows a shorter pulse duration in the case of pulses in UWB signals. As a person skilled in the art with knowledge of the present disclosure will understand, the shorter pulse duration in turn allows a better spatial resolution in the sensor-based detection, monitoring and/or characterization of the passenger compartment. At least according to some specifications, UWB signals have frequencies between 0 GHz and 11 GHz. These frequencies offer, in particular, a better penetration of the signal through the interior (e.g. driver's seats, headrests) and other objects. The coverage of the passenger compartment achieved using these frequencies can accordingly be greater than, for example, with the use of signals in the 24 GHz or 60 GHz band. The greater coverage in turn requires fewer transceivers and therefore a lower integration outlay for the sensor-based detection, monitoring and/or characterization of the passenger compartment.

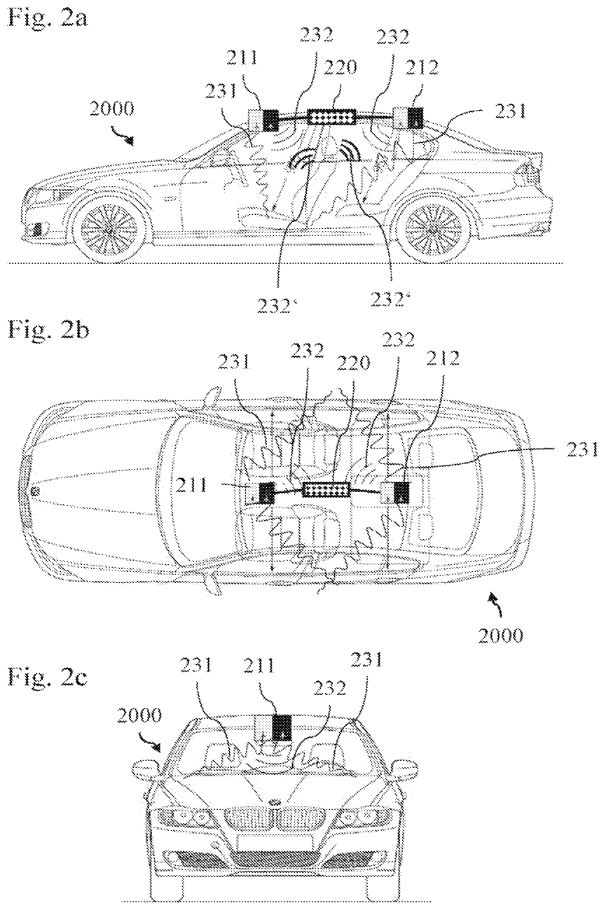

A further exemplary embodiment of the transceiver circuit 100 is described in connection with FIG. 2a, in FIG. 2b and FIG. 2c.

FIGS. 2a, 2b and 2c show a schematic representation of a vehicle 2000 comprising an exemplary embodiment of the transceiver circuit.

Specifically, FIG. 2a shows the vehicle 2000 in a side view, FIG. 2b in a top view, and FIG. 2c in a front view.

As is evident from FIGS. 2a and 2b, the transceiver circuit comprises here a first transceiver 211 and a second transceiver 212, and a control module 220 for the transceivers 211 and 212. The transceivers 211 and 212 are provided for the sensor-based monitoring of different areas in the passenger compartment of the vehicle 2000. The first transceiver 211 is provided here, for example, for an area of a front row of seats, the second transceiver 212 for an area of a rear row of seats of the vehicle 2000. As can be seen, the first transceiver 211 is arranged for this purpose above the front row of seats, and the second transceiver 212 is arranged above the rear row of seats. The transceivers 211 and 212 are arranged, for example, on or in the roof lining of the vehicle 2000. In other exemplary embodiments, the transceivers can also be arranged at other positions in the vehicle, for example in the footwell.

The transceivers 211 and 212 in each case comprise, for example, an antenna array for transmitting and receiving signals, a processor for generating signals or for processing received signals, and an interface with the control module 220 for exchanging information. The transceivers 211 and 212 are implemented here, for example, as UWB transceivers or “UWB anchors”. The antenna array and the processor, for example, are adapted/configured accordingly for the use of UWB.

The transceivers 211 and 212 can in each case transmit a measurement signal 232 for the sensor-based monitoring of the passenger compartment.

As shown in FIGS. 2a, 2b and 2c, the measurement signals 232 can be directed onto the front or rear row of seats in order to cover the corresponding area of the transceivers 211 and 212. The measurement signals 232 can be reflected in the passenger compartment and reflections 232′ of the measurement signals 232 can be received by the transceivers 211 and 212. The reflections 232′ can be understood as an echo of the measurement signals 232 which have been reflected once or multiple times. In particular, the reflections 232′ can comprise a plurality of reflections of the same object according to the multipath reception or multipath propagation principle. In exemplary embodiments, the transceivers 211 and 212 can receive not only reflections of their “own” measurement signal, but also reflections of the measurement signal of the respective other transceiver. The first transceiver 211, for example, can receive not only reflections of the measurement signal 232 which is transmitted by the first transceiver 211 itself, but also reflections of the measurement signal 232 of the second transceiver 212. Information relating to a signal delay, a signal path and/or a Doppler shift of the measurement signal 232 can be gathered on the basis of the received reflections 232′. The information relating to the signal delay, the signal path and/or the Doppler shift can be transmitted to the control module 220. The control module 220 can determine information relating to the passenger compartment on the basis of this information. In exemplary embodiments, the information relating to the passenger compartment comprises information relating to one or more objects and/or occupants, for example relating to the presence, the position, the size, signs of life, the emotional state, the age and/or the state of health of the occupants. The control module 220 can correct the information relating to the passenger compartment in the interests of higher reliability of the information relating to the passenger compartment using redundancies resulting from the use of a plurality of transceivers, here the transceivers 211 and 212.

In alternative exemplary embodiments, “unreflected” signals propagating along the line of sight between transceivers can be used to gather the information relating to the passenger compartment.

The measurement signal 232 is preferably a UWB signal in the interests of higher accuracy of the information relating to the passenger compartment and/or better coverage of the passenger compartment than with the use of other types of signals.

As shown, a communication signal 231 can be transmitted between a communication device of a user, for example a driver or occupant, and at least one or both of the transceivers 211 and 212. The communication signal 231 is received here, for example, by transceivers 211 and/or 212 from the communication device, for example a cell phone, computer, smart watch or tablet. The communication device is located, for example, outside the vehicle 2000. The communication signal comprises, for example, information relating to a location of the communication device and/or a time when a further communication signal transmitted by one of the transceivers 211 and 212 is received. The distance and/or position relative to the vehicle 2000 or to one of the transceivers 211 and 212 can be determined on the basis of the information. The communication signal 231 can further comprise information relating to an authorization and/or a request to lock or unlock the vehicle. The control module 220 can instigate a locking or unlocking of the vehicle 2000 on the basis of the information relating to the position, the distance, the authorization and/or the request to lock or unlock the vehicle. One or more vehicle doors, for example, and/or a trunk of the vehicle can be unlocked automatically or at the request of the user or of the communication device if the communication device is within a specific range, i.e. if the distance of the communication device falls below a predetermined threshold value.

The communication signal 231 can also be a signal which is transmitted to the communication device of the user. In this case, the communication signal 231 is adapted in such a way that the communication signal 231 can be received by the communication device of the user outside the passenger compartment. To do this, the communication signal 231 can be emitted into the environment of the vehicle. In this way, the communication device can, as described above, be prompted to transmit information relating to the location of the communication device, the time when the communication signal 231 is received, the authorization and/or the request to lock or unlock the vehicle to at least one of the transceivers 211 and 212 by means of a further communication signal.

Information relating to the gathering of information relating to the passenger compartment and information relating to the locking/unlocking of the vehicle can be processed using separate software blocks, for example using separate computer programs which are implemented in each case in one of the transceivers 211 and 212. The information, for example, relating to the signal delay, the signal path and/or the Doppler shift is processed in each case using a first computer program implemented in the transceivers 211 and 212, and information relating to the position, distance, authorization and/or request to lock/unlock the vehicle 2000 is processed in each case using a second separate computer program implemented in the transceivers 211 and 212.

The communication signal 231 is preferably a UWB signal in the interests of f less interference and better encryption than with the use of other types of signals. Alternatively, however, other types of signals can also be used.

The control module 220 can use the information relating to the locking of the vehicle 2000 and the information relating to the passenger compartment of the vehicle 2000, in particular, for protection against theft and/or for the protection of occupants. The presence of persons/animals and/or movements in the passenger compartment following the locking of the vehicle 2000 indicate, for example, an attempted theft and/or that a person or an animal has been (unintentionally) left behind in the vehicle. The control module 220 can trigger an alarm in this way on the basis of the information relating to the passenger compartment and the information relating to the locking for protection against theft or for the protection of occupants. The alarm comprises, for example, generating an audible or visual signal to alert the environment of the vehicle to the theft or persons or animals left behind, and/or transmitting a notification to the communication device of the user.

The proposed concept can also be implemented in a corresponding method.

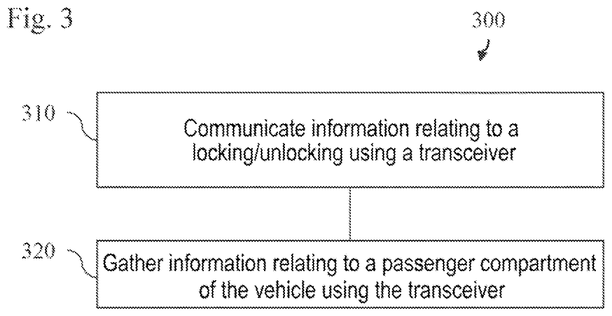

FIG. 3 shows a flow diagram for the schematic illustration of an exemplary embodiment of a method 300 for a vehicle.

The method 300 comprises communicating 310 information relating to the locking of vehicle with a communication device of a user using a transceiver. The method 300 further comprises gathering 320 information relating to a passenger compartment of the vehicle using the transceiver. Producing the same effect as the proposed concept for the transceiver circuit, integration outlay for occupant detection and communication with a communication device for locking/unlocking the vehicle can thereby be reduced.

It should be noted that features that have been described in connection with the transceiver circuit can be implemented analogously in a method, here, for example, in the method 300.

The proposed concept can also be implemented in a corresponding computer program.

Exemplary embodiments provide, for example, a computer program having a program code which causes the method 300 to be carried out when the program code is executed on a programmable hardware component.

Further exemplary embodiments are computer programs to carry out one of the methods described herein when the computer program runs on a computer, a processor, or a programmable hardware component. Depending on specific implementation requirements, exemplary embodiments can be implemented in hardware or in software. The implementation can be performed using a digital storage medium, for example a floppy disk, a DVD, a Blu-ray disc, a CD, a ROM, a PROM, an EPROM, an EEPROM or a FLASH memory, a hard disk or other magnetic or optical storage device on which electronically readable control signals are stored which can interact or interact a with programmable hardware component in such a way that the respective method is carried out.

A programmable hardware component can be formed by a processor, a computer processor (CPU=Central Processing Unit), a graphics processor (GPU=Graphics Processing Unit), a computer, a computer system, an application-specific integrated circuit (ASIC), an integrated circuit (IC), a system on chip (SOC), a programmable logic element or field-programmable gate array (FPGA) with a microprocessor.

The digital storage medium can therefore be machine-readable or computer-readable. Some exemplary embodiments therefore comprise a data medium which has electronically readable control signals which are capable of interacting with a programmable computer system or a programmable hardware component in such a way that one of the methods described herein is carried out. One exemplary embodiment is therefore a data medium (or a digital storage medium or a computer-readable medium) on which the program to carry out one of the methods described herein is recorded.

Generally speaking, exemplary embodiments can be implemented as a program, firmware, computer program or computer program product having a program code, or as data, wherein the program code or the data is/are instrumental in carrying out one of the methods when the program runs on a processor or a programmable hardware component. The program code or the data can, for example, be stored on a machine-readable medium or data medium. The program code or the data can be present, inter alia, as source code, machine code or byte code, and also as a different intermediate code.

The exemplary embodiments described above merely represent an illustration of the principles of the present disclosure. Modifications and variations of the arrangements described herein and details will obviously be apparent to other persons skilled in the art. It is therefore intended that the scope of protection extends to the patent claims below, and not merely to the specific details which have been presented herein on the basis of the description and the explanation of the exemplary embodiments.

### REFERENCE SIGN LIST

100 Transceiver circuit
110 Transceiver
120 Control module
211 First transceiver
212 Second transceiver
220 Control module
231 Communication signal
232 Measurement signal
232′ Reflection
300 Method
310 Communicate information relating to a locking/unlocking using a transceiver
320 Gather information relating to a passenger compartment of the vehicle using the transceiver
1000 Vehicle
2000 Vehicle

1.-12. (canceled)

13. A transceiver circuit for a vehicle, the transceiver circuit comprising:
at least one transceiver, and
a control module for the transceiver, wherein the control module is configured to
communicate information relating to a locking/unlocking of the vehicle with a communication device of the user using the transceiver, and
gather information relating to a passenger compartment of the vehicle using the transceiver.

14. The transceiver circuit as claimed in claim 13, wherein the transceiver comprises an ultra-wideband transceiver.

15. The transceiver circuit as claimed in claim 13, wherein the transceiver is arranged in the passenger compartment vehicle.

16. The transceiver circuit as claimed in claim 13, wherein the transceiver is configured to:
transmit a communication signal to communicate the information relating to the locking/unlocking of the vehicle between the communication device and the transceiver; and
transmit a measurement signal into the passenger compartment in order to gather the information relating to the passenger compartment using the measurement signal or a reflection of the measurement signal.

17. The transceiver circuit as claimed in claim 16, wherein the transceiver circuit comprises at least one further transceiver which is designed to receive the measurement signal or the reflection of the measurement signal, and wherein the control module is designed to gather the information relating to the passenger compartment of the vehicle using the received measurement signal or the reflection of the measurement signal.

18. The transceiver circuit as claimed in claim 16, wherein the communication signal is a first ultra-wideband signal and the measurement signal is a second ultra-wideband signal.

19. The transceiver circuit as claimed in claim 16, wherein the communication signal and the measurement signal have a frequency between 1 GHz and 20 GHz.

20. The transceiver circuit as claimed in claim 16, wherein the information relating to the passenger compartment comprises information relating to one or more occupants of the passenger compartment.

21. The transceiver circuit as claimed in claim 20, wherein the information relating to the passenger compartment comprises information relating to a presence, a position, a sign of life, an emotional state, age and/or state of health of the occupants.

22. The transceiver circuit as claimed in claim 13, wherein the information relating to the passenger compartment comprises information relating to one or more occupants of the passenger compartment.

23. The transceiver circuit as claimed in claim 22, wherein the information relating to the passenger compartment comprises information relating to a presence, a position, a sign of life, an emotional state, age and/or state of health of the occupants.

24. The transceiver circuit as claimed in claim 22, wherein the control module is further configured to use the information relating to the locking/unlocking of the vehicle and the information relating to the passenger compartment of the vehicle to cause an operation to be performed corresponding to detection of an attempted theft and/or corresponding to protection of at least of the one or more occupants.

25. The transceiver circuit as claimed in claim 13, wherein the control module is further configured to use the information relating to the locking/unlocking of the vehicle and the information relating to the passenger compartment of the vehicle to cause an operation to be performed corresponding to detection of an attempted theft and/or corresponding to protection of one or more occupants of the vehicle.

26. A vehicle comprising a transceiver circuit as claimed in claim 13.

27. A method for a vehicle, the method comprising:
communicating information relating to a locking/unlocking of the vehicle with a communication device of a user using a transceiver; and
gathering information relating to a passenger compartment of the vehicle using the transceiver.

28. A computer-readable storage medium on which a computer program is saved, the computer program comprising instructions, which when executed by a computer, cause performance of the method of claim 15.
